(19) United States
(12) Patent Application Publication
(10) Pub. No.: US 2025/0383201 A1
(43) Pub. Date: Dec. 18, 2025

(54) SURVEYING SYSTEM AND SURVEYING METHOD

(71) Applicant: TOPCON CORPORATION, Tokyo-to (JP)

(72) Inventor: Nobuyuki Nishita, Tokyo-to (JP)

(21) Appl. No.: 19/232,116

(22) Filed: Jun. 9, 2025

(30) Foreign Application Priority Data
Jun. 12, 2024 (JP) 2024-095099

(51) Int. Cl. G01C 15/06; G01C 15/00; G06V 20/20

(52) U.S. Cl. CPC G01C 15/06; G01C 15/008; G06V 20/20

(57) ABSTRACT

A surveying system and method are provided that allow a user to visually confirm measurement data of a measurement target from a position different from the measuring device. The surveying system includes a measuring device and a portable terminal. The measuring device is movable and includes a measuring instrument for measuring a measurement target, an AR marker having a known positional relationship with a measurement reference position of the measuring instrument, a control module configured to convert acquired measured data into data referenced to the AR marker, and a communication module configured to transmit the converted data. The portable terminal includes a camera configured to capture an image including the AR marker, a terminal communication module for receiving the converted data, a terminal control module, and a display unit. The terminal control module is configured to recognize the AR marker from the image, generate an AR image based on the recognized marker and the converted data, and display the AR image on the display unit.

### TECHNICAL FIELD

The present disclosure relates to a surveying system and a surveying method in which a portable terminal is configured to display measured data of a measurement target, in real time, on a display unit of the portable terminal located at an arbitrary position, as measured data with reference to the position of the portable terminal.

### BACKGROUND ART

Conventionally, measured data (e.g., three-dimensional distance measurement data) has been obtained by a measuring device and acquired as distance measurement data with an image, in which the measured data is overlaid on an image of a measurement target, to facilitate understanding of the measurement situation. Alternatively, measured data has been displayed in real time on a display unit of the measuring device as an image with distance measurement data.

Here, it is measurement operators, who operate the measuring device, that visually check the image with the distance measurement data using the display unit of the measuring device, allowing the operator to monitor the measurement state while carrying out the measurement.

Furthermore, measuring operations and construction work, based on the measurement results from the measuring operations, may be either carried out in parallel. In such a case, the construction work is carried out by construction workers according to instructions of the measurement operators, or is carried out while the construction workers check the construction state after each construction step is completed, either of which results in poor workability. Accordingly, it is desirable that the system be configured to allow measurement operators to check the measurement results directly at the construction site.

### CITATION LIST

### Patent Literature

[Patent Literature 1] JP 2023-50332 A
[Patent Literature 2] JP 2005-140523 A
[Patent Literature 3] JP 2006-84346 A
[Patent Literature 4] JPH 09-210687 A
[Patent Literature 5] JP 2004-45159 A

### SUMMARY

### Technical Problem

It is an object of the present disclosure to provide a surveying system and a surveying method that enable visual checking of measurement results (measured data) of an measurement target obtained by a measuring device, from a position different from that of the measuring device, as measurement data with reference to that different position.

### Solution to Problem

An aspect of the present invention is, a surveying system comprising a measuring device and a portable terminal, each comprising: one or more hardware-processors, one or more memories, and one or more programs stored in the one or more memories, the one or more programs being executable by the one or more hardware-processors, to cause the one or more hardware-processors to collectively perform operations, wherein the measuring device comprises a measuring instrument configured to measure a measurement target, an AR marker disposed in a known positional relationship with a measurement reference position of the measuring instrument, a control module configured to convert measured data acquired by the measuring instrument into measured data with reference to the AR marker, and a communication module configured to transmit the converted measured data, and wherein the portable terminal comprises a camera configured to capture an image of the measurement target and the AR marker, a terminal communication module configured to receive the converted measured data, a terminal control module, and a display unit, wherein the terminal control module is configured to recognize the AR marker from the captured image, to create an AR image based on the recognized AR marker and the converted measured data, and to display the AR image on the display unit.

An aspect of the present invention is, the surveying system wherein the AR marker comprises a predetermined pattern, and wherein the terminal control module is further configured to calculate a viewing orientation of the measurement target as viewed from the portable terminal based on the predetermined pattern, to calculate a relative position and a posture of the measuring device with respect to the portable terminal based on recognition of a shape of the pattern, and to correct a displayed position of the AR image on the display unit based on the calculated viewing orientation, relative position, and posture.

An aspect of the present invention is, the surveying system wherein the measuring device further comprises a tilt sensor, and wherein the control module is further configured to correct the converted measured data based on a detection result of the tilt sensor.

An aspect of the present invention is, the surveying system wherein the surveying system further comprises a reference level measuring device configured to set a reference level with respect to the measurement target, and wherein the converted measured data is unevenness data with respect to the reference level.

An aspect of the present invention is, the surveying system wherein the control module is configured to create an unevenness map with colors corresponding to the unevenness data.

An aspect of the present invention is, the surveying system wherein the reference level measuring device comprises a photodetector provided on the measuring device and a laser level planer configured to form a reference plane at a predetermined distance with respect to the measurement target.

An aspect of the present invention is, the surveying system wherein the reference level measuring device comprises a prism provided on the measuring device and a total station provided at a known height.

An aspect of the present invention is, the surveying system wherein the surveying system further comprises a second measuring instrument configured to acquire information of the measurement target and wherein the terminal control module is configured to create the AR image based on the converted measured data and information acquired by the second measuring instrument.

An aspect of the present invention is, a surveying method used in a surveying system comprising a measuring device including an AR marker and a portable terminal including a display unit, wherein the surveying method comprising steps performed by one or more hardware processors executing one or more programs stored in one or more memories, the one or more programs being executable by the one or more hardware processors to cause the one or more hardware processors to perform operations comprising, measuring a measurement target using the measuring device to acquire measured data, converting the measured data into data with reference to the AR marker, transmitting converted measured data to the portable terminal, acquiring an image of the measurement target, the image includes the AR marker, recognizing the AR marker from the image, creating an AR image based on a result of the recognition of the AR marker and the converted measured data, and displaying the AR image on the display unit.

### Advantageous Effect of Invention

According to the present disclosure, it is possible to recognize the AR marker even under bright construction site and to observe surface properties of an measurement target surface.

### BRIEF DESCRIPTION OF DRAWINGS

FIG. 1 is a schematic block diagram of a surveying system according to a first embodiment of the present disclosure.

FIG. 2 is a schematic drawing of a surveying system according to a second embodiment.

FIG. 3 is a schematic block diagram of a laser level planer.

FIG. 4 is a schematic block diagram of a pole device.

FIG. 5 is a schematic block diagram of a portable terminal.

FIG. 6 is an explanatory drawing regarding the measurement of an unevenness state.

FIG. 7 is an explanatory drawing of an unevenness map.

FIG. 8 is a drawing showing a portable terminal with an AR image displayed on a terminal display unit thereof.

FIG. 9 is a flow chart of an unevenness measurement in a pole device.

FIG. 10 is a flow chart of an unevenness measurement in a portable terminal.

FIG. 11 is a schematic drawing of a surveying system according to a third embodiment.

FIG. 12 is a schematic block diagram of a total station in the third embodiment.

FIG. 13 is a schematic block diagram of a pole device in the third embodiment.

FIG. 14 is an explanatory drawing regarding the measurement of an unevenness state in the third embodiment.

FIG. 15 is a schematic drawing of a surveying system according to a fourth embodiment.

### DESCRIPTION OF EMBODIMENTS

Embodiments of the present disclosure will be described below with reference to the accompanying drawings.

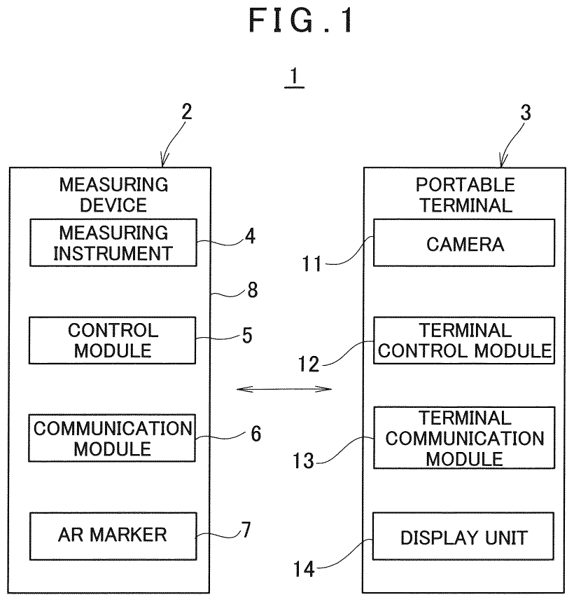

FIG. 1 illustrates a first embodiment of the present disclosure.

The surveying system 1 according to the present disclosure basically includes a measuring device 2 and a portable terminal 3.

The measuring device 2 includes a measuring instrument 4, a control module 5, a communication module 6, and an Augmented Reality (AR) marker 7, all of which are provided on a movable support 8, and the AR marker 7 is provided at a known position with respect to the measuring instrument 4.

A measurement operator may move the measuring device 2 to different locations by moving the support 8, so that the operator can measure at the site to which the operator has moved.

The portable terminal 3 is a handheld device and includes a camera 11, a terminal control module 12, a terminal communication module 13, and a display unit 14.

The measuring instrument 4 measures the distance and shape of an measurement target located the vicinity of the measuring device 2, and acquires measured data, such as distance measurement data or planar property data.

The control module 5 is a processing device comprising, for example, one or more processors and memory, and is configured to convert the measured data (i.e., measurement results) into measured data that includes position information with respect to the AR marker 7. converts the measured data (i.e., measurement results) into measured data that includes position information with respect to the AR marker 7, as described later.

The portable terminal 3 acquires a local image of the measurement target including the AR marker 7, using the camera 11, which captures the images from an arbitrary position with respect to the measuring device 2.

Upon receiving an information request from the portable terminal 3, the control module 5 transmits the measured data to the portable terminal 3 via the communication module 6.

The portable terminal 3 acquires the measured data via the terminal communication module 13. This measured data represents values with reference to the position of the measuring device 2.

The terminal control module 12 is a processing device comprising, for example, one or more processors and memory, and is configured to extracts an image of the AR marker 7 from the local image, reads out the information encoded in the AR marker 7 from the extracted image, and calculates an orientation of the portable terminal 3 with respect to the AR marker 7 from the encoded information.

Further, the terminal control module 12 converts the measured data into local measured data with reference to the position of the portable terminal 3, based on the calculated orientation of the portable terminal 3, and incorporates the local measured data with the local image to create a local image including the measured data.

The terminal control module 12 displays this local image including the measured data on the display unit 14.

Accordingly, the surveying system 1 allows the measurement operator carrying the portable terminal 3 to monitor the measured data in real time, displayed on the display unit 14 with an image of the measurement target overlaid, the image being captured from an arbitrary position and orientation.

Thus, when measurement operations and construction work based on measurement results are carried out in parallel, it becomes possible to view the construction state and check the measurement results in real time using the portable terminal 3, thereby improving the efficiency and productivity of the construction work.

As examples of the measured data acquired by the measurement instrument 4, when the measurement target is planer, the data includes planar properties (e.g., planarity, irregularity, curvature, and tilt) and surface cracks. When the measurement target is a three-dimensional object, the data includes shape data of the object. Furthermore, when the measurement target is a plane with a large irregularity such as a stepcase, the data also includes the position, height, and size of the irregularity.

Then, a second embodiment will be described, in which the measurement target of the present surveying system is a planar surface, and the system is applied to unevenness measurement of a concrete casting surface.

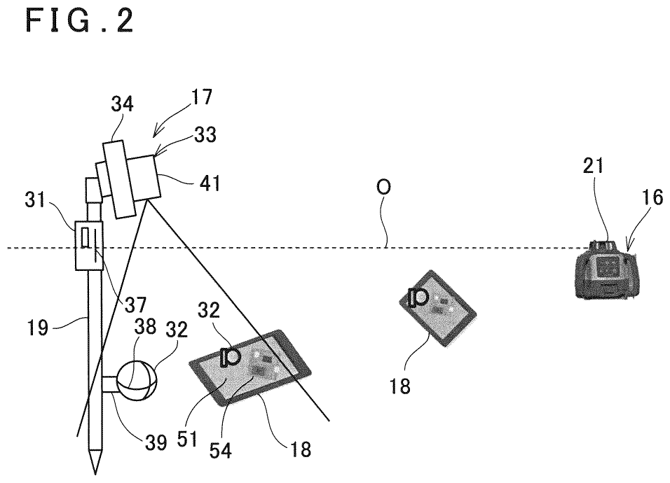

FIG. 2 shows general features of a surveying system according to the second embodiment. The surveying system 1 mainly includes a height measuring device 16, a pole device 17, and a portable terminal 18. The pole device 17 includes a pole 19 (as described later) as a movable support, and the measuring instrument 4 (see FIG. 1) in the first embodiment is provided on the pole 19.

A laser level planer 21 is employed as the height measuring device 16 in the second embodiment. It is to be noted that examples of the laser level planer 21 are disclosed in the patent literatures 2 to 5.

The laser level planer 21 forms a horizontal reference plane with a predetermined height by using a laser beam. The horizontal reference plane may be formed by rotatably emitting the laser beam on a horizontal plane or may be formed by horizontally emitting a fan-shaped laser beam. The following explanation describes an instance where a horizontal reference plane O is formed by rotatably emitting the laser beam on a horizontal plane.

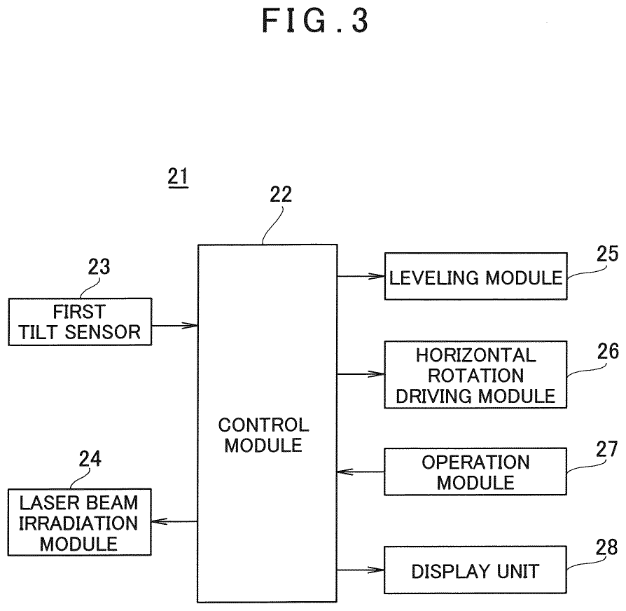

With reference to FIG. 3, a description will be given of general features of the laser level planer 21.

The laser level planer 21 is installed at a position using a support device (not shown in FIG. 3), such as a tripod. The laser level planer 21 mainly includes a control module 22, a first tilt sensor 23, a laser beam irradiation module 24, a leveling module 25, a horizontal rotation driving module 26, an operation module 27, and a display unit 28.

The first tilt sensor 23 detects the tilt of the laser level planer 21 with respect to the horizontal plane, that is, the tilt of the laser beam as emitted with respect to the horizontal plane. A detected result from the first tilt sensor 23 is input into the control module 22.

The control module 22 drives the leveling module 25 based on the detected result of the first tilt sensor 23, and adjusts the laser level planer 21 to the horizontal plane. The control module 22 causes the laser beam irradiation module 24 to emit the laser beam, and causes the horizontal rotation driving module 26 to rotate the laser beam irradiation module 24 so as to rotatably emit the laser beam such that the horizontal reference plane O is formed.

The laser level planer 21 is installed such that the horizontal reference plane O is set at a known height. For instance, the height of the horizontal reference plane O from a reference floor surface is known, based on actual measurements, specifications of the laser level planer 21, and other related information. When the known horizontal reference plane O is formed, it becomes possible to measure the height of the measurement target surface with reference to the horizontal reference plane O and the height of the irregularity on the surface with reference to the horizontal reference plane O.

The operation module 27 receives input operations for laser level planer 21 from the measurement operator, including turning ON/OFF, configuration settings, and condition setting of each operation. The display unit 68 the operating state of the laser level planer 21 as affected by these operations.

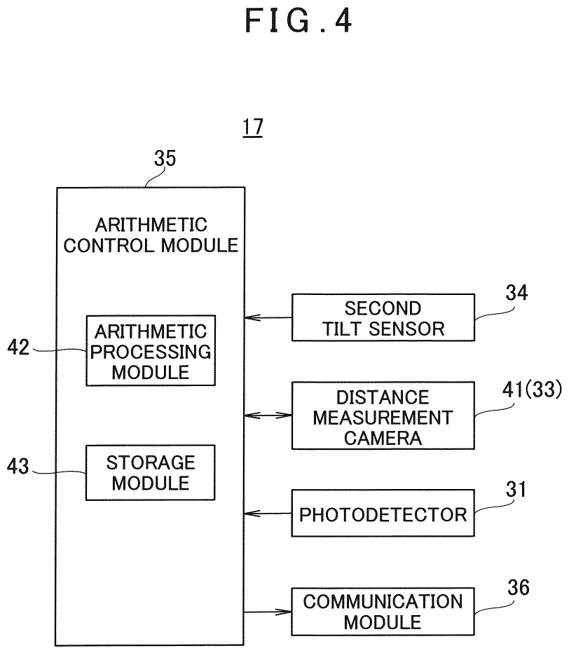

With reference to FIG. 2 and FIG. 4, the pole device 17 will be described.

The pole device 17 acquires measured data its vicinity, functioning as a measuring device 2 (see FIG. 1).

The pole device 17 includes a pole 19 that functions as a movable support; a photodetector 31, as an measurement target, provided on the pole 19 at a height; an AR marker 32 provided on the pole 19 at a position lower than the photodetector 31; a distance measurement sensor 33 as a measuring instrument provided on the top of the pole 19; a second tilt sensor 34, an arithmetic control module 35; and a communication module 36.

A photodetection reference position of the photodetector 31 and a measurement reference position of the distance measurement sensor 33 are set to a known positional relationship, and a measurement reference position of the distance measurement sensor 33 and a reference position of the AR marker 32 are set to a known relationship.

The photodetector 31 includes a photodetection sensor 37 that extends vertically with a predetermined length, and the photodetection sensor 37 detects the laser beam and produces a detecting signal. The photodetection sensor 37 has the photodetection reference position (e.g., the vertical center or the lower end of the photodetection sensor 37), and the photodetection reference position is a known position in the pole device 17. For instance, a distance between the photodetection reference position and the lower end of the pole 19 is known.

The detecting signal includes a photodetecting signal and a detecting position information. The detecting position information includes a deviation with respect to the photodetection reference position. Thus, based on the detecting signal, it becomes possible to measure the height (a level of the reference position) of the photodetection reference position with respect to the horizontal reference plane O. The detecting signal is input into the arithmetic control module 35.

The laser level planer 21, which forms the horizontal reference plane O, and the photodetection sensor 37, which detects the position of the horizontal reference plane O, work together to measure a level, which serves as a measurement reference of unevenness measurement and function as a reference level measuring device.

The AR marker 32 includes information for identifying the viewing orientation. The AR marker 32 may be, for example, a sphere that has a predetermined pattern 38 formed on a surface thereof, and is attached to the pole 19 via a supporting part 39. Further, a marker reference position in the AR marker 32, for example, a position of a geometric center of the sphere is in a known position in the pole device 17, for example, as previously described, the relationship between the measurement reference position of the distance measurement sensor 33 and the reference position of the AR marker 32 are known.

The pattern 38 has a patterned design or figure with a predetermined shape, and is configured such that the shape of the pattern appears differently depending on the viewing angle of the AR marker 32. Thus, it becomes possible to identify the viewing angle of the AR marker 32 based on the shape of the pattern 38 with respect to the optical axis of the camera when an image of the AR marker 32 is captured.

It is to be noted that the AR marker 32 is not limited to a sphere on which the pattern 38 is formed, and may be a plate or a cube on which the pattern 38 is formed, a three-dimensional object having a unique shape, a pattern, or even a planar pattern, which allows identification of the viewing orientation. Alternatively, the pattern 38 may be a specific picture or an image. That is, the pattern 38 may have any form, as long as it enables identification of an orientation or a size, and functions as the AR marker 32.

The distance measurement sensor 33 is oriented downward to measure the distance to the ground surface, and can be implemented using various types of distance measurement sensors. Examples include a distance measurement camera, a laser scanner, and a stereo camera. In the following embodiment, a distance measurement camera 41 is employed, for example, for illustrative purposes.

The distance measurement camera 41 includes an imaging element consisting of many pixels. The distance measurement camera 41 emits a distance measuring light from each pixel and receives a reflected light at each pixel for the distance measurement based on the Time Of Flight (TOF) principle, and acquires the distance measurement data in a planar manner, similar to an image. The distance measurement data output from each pixel includes position information on the imaging element. The distance measurement data is input into the arithmetic control module 35. Alternatively, the distance measurement data may also be acquired in a planer manner by performing high-speed two-dimensional scanning of the distance measurement light. The distance measurement data may be transmitted to the portable terminal 18 in real time via the communication module 36.

The distance measurement camera 41 has a measurement reference position, and measures distance from the measurement reference position. Further, the positional relationship between the measurement reference position of the distance measurement camera 41 and the photodetection reference position of the photodetection sensor 37 is known, and the vertical distance between the measurement reference position and the photodetection reference position is also known.

Thus, measuring the height of the horizontal reference plane O using the photodetection sensor 37 allows the height of the measurement reference position with respect to the horizontal reference plane O to be acquired. Further, the distance measurement data can be converted to distance data with reference to the horizontal reference plane O.

The positional relationship between the measurement reference position and the marker reference position is known, and the positional relationship between an optical axis of the distance measurement camera 41 and the marker reference position is also known.

The second tilt sensor 34 detects the tilt of the distance measurement camera 41 either with respect to the horizontal plane or to the vertical direction of the optical axis, or alternatively, the tilt of the pole 19 with respect to the vertical direction. The tilt detection result from the second tilt sensor 34 is input into the arithmetic control module 35. Alternatively, the tilt detection result from the second tilt sensor 34 may be transmitted to the portable terminal 18 in real time via the communication module 36.

The optical axis of the distance measurement camera 41 is inclined at a predetermined angle with respect to the pole 19. It is to be noted that, when the second tilt sensor 34 is configured to detect the tilt of the pole 19 with respect to the vertical direction, the optical axis of the distance measurement camera 41 is inclined at a known angle with respect to the axis center of the pole 19.

The second tilt sensor 34 may be incorporated in the arithmetic control module 35. Further, the second tilt sensor 34 may employ various types of inertial measurement unit (IMU) sensors, such as an acceleration sensor or a gyroscope sensor.

The arithmetic control module 35 includes an arithmetic processing module 42 and a storage module 43. The arithmetic processing module 42 may employ a dedicated Central Processing Unit (CPU) for the present embodiment, a general-purpose CPU, an embedded CPU, a microprocessor, or other types of processors. Further, the storage module 43 may be implemented using semiconductor memory, such as Random Access Memory (RAM), Read-Only Memory (ROM), Flash ROM, or Dynamic Random Access Memory (DRAM), or magnetic storage memory, such as a Hard Disk Drive (HDD).

The communication module 36 transmits and receives data from and to the portable terminal 18, and receives various commands from the portable terminal 18.

The arithmetic processing module 42 deploys various types of programs stored in the storage module 43, performs processes and operations, and controls the photodetector 31, the communication module 36, the distance measurement camera 41, and the storage module 43 to enable necessary operations at appropriate timing.

The storage module 43 stores various types of programs to be executed in the present embodiment. The programs include a distance measurement program for controlling the distance measurement camera 41 to capture images and measure the distance; an arithmetic program for calculating three-dimensional data based on the distance measurement data; a conversion program for converting the calculated three-dimensional data into three-dimensional data (unevenness distribution) with reference to the AR marker 32 based on a positional relationship between a measurement reference position and a marker reference position; a program for calculating a video signal based on the converted three-dimensional data; a communication program for transmitting and receiving distance measurement data; image data; and various types of commands. Further, the storage module 43 stores various types of data, including a threshold value for determining a high-low state, a measurement result, and image data.

The term “high-low state” refers to a condition including a deviation with respect to a set height of the measurement target surface, the surface irregularities (unevenness) with respect to a set plane, and the tilt with respect to a horizontal plane. Further, the “high-low information” includes data indicating a deviation with respect to the set height of the measurement target surface, the unevenness with respect to the set plane, the tilt with respect to the horizontal plane.

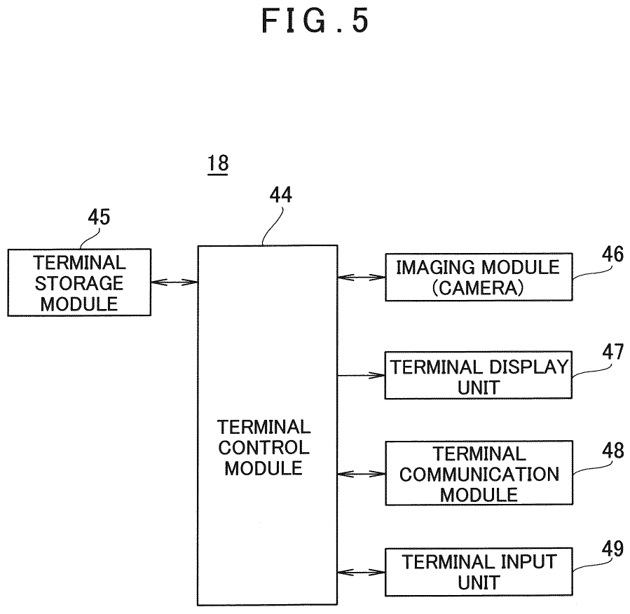

With reference to FIG. 5, the portable terminal 18 will be described.

The portable terminal 18, corresponding to the portable terminal 3 shown in FIG. 1, may be a dedicated terminal device for the present embodiment; or a general-purpose device such as a smartphone, a tablet, an eyeglass-type terminal device including Virtual Reality (VR) goggles, a head-mounted display (HMD), and a portable PC; each of which includes a processing module, a display unit, and a communicating unit. A portable terminal in which a program for adapting the present embodiment is installed.

The portable terminal 18 includes a terminal control module 44, a terminal storage module 45, an imaging module 46, a terminal display unit 47, a terminal communication module 48, and a terminal input unit 49.

An example of the imaging module 46 is a camera, which captures at least a measurement target surface so as to include the AR marker 32, and provides the image data to the terminal control module 44.

The terminal display unit 47 displays an AR image 51 (see FIG. 2) created based on unevenness distribution transmitted from the pole device 17 and an image of the measurement target surface. The terminal communication module 48 transmits and receives data between the pole device 17 and the portable terminal 18.

The terminal storage module 45 stores various types of programs for operating the portable terminal 18. The program includes, for example, an AR marker recognizing program for recognizing the AR marker 32 in the image acquired by the imaging module 46 and detecting a shape of the pattern 38, an orientation, a tilt, a tilt direction, and a size with respect to an optical axis of the imaging module 46, a position arithmetic program that calculates a relative position of the AR marker 32 with respect to the imaging module 46 by comparing the recognized pattern 38 and a pattern image (as described later), a posture arithmetic program that calculates an orientation of an distance measuring optical axis of the distance measurement camera 41 with respect to the optical axis of the imaging module 46, that is, a posture of the pole device 17, based on a position of the AR marker 32 and a known positional relationship between a measurement reference position of the distance measurement camera 41 and a marker reference position of the AR marker 32, a communication program for transmitting data to and receiving data from the pole device 17, an AR image creation program that creates the AR image 51 with reference to a position of the portable terminal 18 based on a positional relationship between an unevenness distribution received from the pole device 17 and the AR marker 32, and a displaying program for displaying the created AR image 51 on the terminal display unit 47.

Further, the terminal storage module 45 stores a plurality of pattern images of the pattern 38, which are used for recognizing the AR marker 32. Each pattern image is associated with the shape of the pattern 38 and the posture of the pole device 17. The posture of the pole device 17 can be determined by recognizing the pattern 38 from the image captured by the imaging module 46 and identifying a correspond patten image that matches the recognized pattern 38. It is to be noted that a pattern image may be created on an ad-hoc basis using a creation program, for example, based on a three-dimensional image of the pattern 38 stored in the terminal storage module 45.

The terminal control module 44 deploys a program stored in the terminal storage module 45, performs processing, and controls the terminal storage module 45, the imaging module 46, the terminal display unit 47, and the terminal communication module 48 to enable necessary operations at appropriate timing.

The terminal control module 44 recognizes the pattern 38 of the AR marker 32 from an image of the measurement target acquired by the AR marker recognizing program, and can detect the orientation, the tilt, the tilt direction, the size of the AR marker 32 with respect to the optical axis of the imaging module 46 based on the pattern 38. Thus, the imaging module 46 and the terminal control module 44 collectively constitute an AR marker recognizing unit.

Further, based on the detected pattern 38, the terminal control module 44 calculates the relative position of the AR marker 32 with respect to the imaging module 46 and the relative posture of the pole device 17 with respect to the imaging module 46 (i.e., the portable terminal 18).

Further, based on an AR image creation program, the terminal control module 44 creates an AR image 51 (as described later) with reference to a position of the portable terminal 18. The AR image 51, which includes the unevenness distribution, is created based on the unevenness distribution received from the pole device 17, the image captured by the imaging module 46, and the positional relationship with the AR marker 32. The terminal control module 44 displays the AR image 51 on the terminal display unit 47.

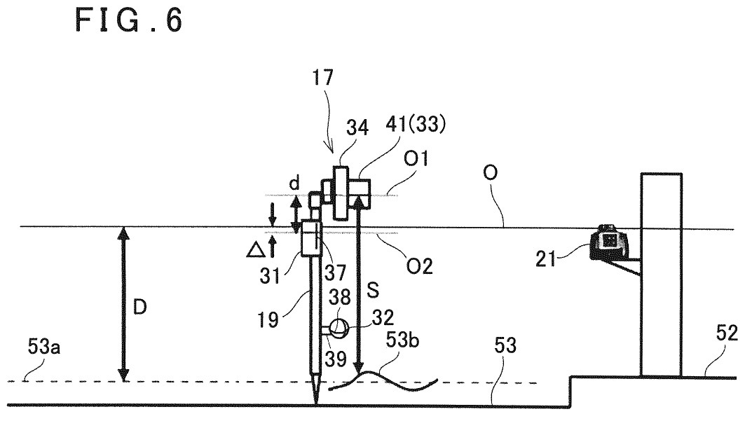

With reference to FIG. 6, a description will be given of an instance where the measurement target surface is a floor surface, and the unevenness state of the floor surface is measured.

In FIG. 6, reference numeral 52 denotes a floor surface serving as a reference. The laser level planer 21 is installed at a known height with respect to the floor surface 52, and forms a horizontal reference plane O at a known height with respect to the floor surface 52. A construction floor surface 53, which lies below the floor surface 52 by a predetermined amount, is finished with concrete and the construction finished surface is denoted by reference numeral 53a.

For instance, a measurement operator places the pole 19 on the construction floor surface 53 and holds the pole device 17 vertically or substantially vertically. A vertical state of the pole device 17 is detected by the second tilt sensor 34.

The following description assumes that the pole device 17 is vertically supported.

In FIG. 6, a reference numeral O1 denotes a horizontal line that passes through a measurement reference position of the distance measurement camera 41, and O2 denotes a horizontal line that passes through a photodetection reference position of the photodetection sensor 37. The construction finished surface 53a is set to a height difference D with respect to the horizontal reference plane O to obtain a predetermined height for placing the concrete.

As described above, the measurement reference position and the photodetection reference position have a known positional relationship, and the distance between horizontal line O1 and O2 is a known value d. A deviation Δ is defined between the laser beam receiving position and the photodetection reference position of the photodetection sensor 37 (i.e., the deviation Δ between the horizontal reference plane O and the photodetection reference position). A distance measurement value S is defined as the distance measured by the distance measurement camera 41 to the construction surface 53b (i.e., the concrete placing surface), that is, the distance between the measurement reference position of the distance measurement camera 41 and the construction surface 53b.

The unevenness ΔF (i.e., the height difference) of the construction surface 53b with reference to the construction finished surface 53a is calculated using the following expression.

$$Δ F = D + ( d - Δ ) - S \qquad ( Expression 1 )$$

Where Δ is positive (+) when the laser beam receiving position is above the photodetection reference position, and negative (−) when it is below. Further, with respect to the unevenness ΔF, a positive value indicates that the construction surface 53b is convex relative to the construction finished surface 53a, and a negative value indicates that it is concave.

The height difference D and the distance d between the measurement reference position and the photodetection reference position are preset in the arithmetic control module 35. A distance measurement result from the distance measurement camera 41 and a detecting signal of the photodetection sensor 37 are each input into the arithmetic control module 35. The arithmetic control module 35 calculates the unevenness ΔF based on the height difference D, the distance d, the distance measurement result, and the detecting signal.

Further, the distance measurement camera 41 performs distance measurement on a per-pixel basis of the imaging element, and the arithmetic control module 35 calculates the unevenness ΔF on a per-pixel basis, thereby acquiring the unevenness ΔF data and the unevenness ΔF distribution across the full angle of the field of the distance measurement camera 41 in real time.

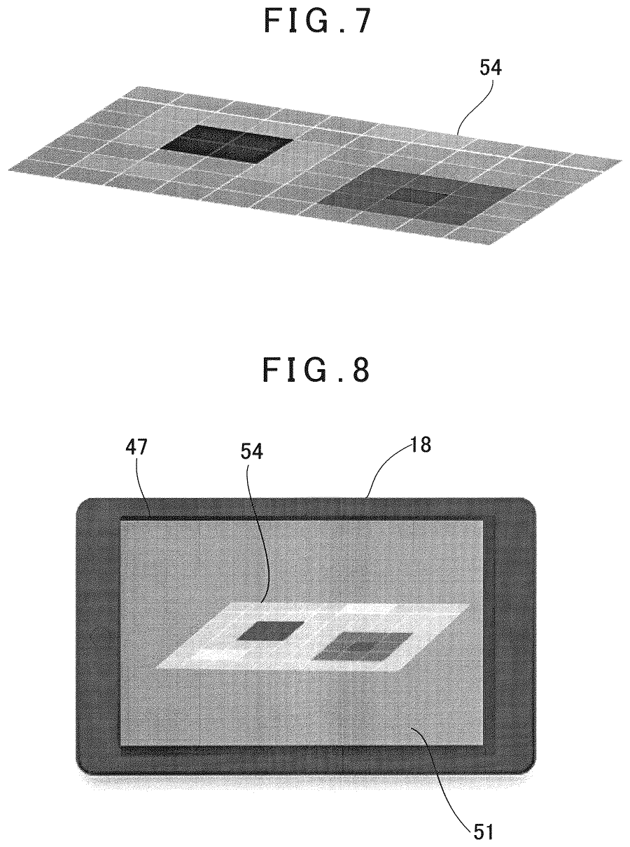

Further, the arithmetic control module 35 classifies the unevenness ΔF using a threshold value stored in the storage module 43, and creates an unevenness map 54 (see FIG. 7).

The unevenness map 54 can visualize the unevenness ΔF as a heat map, with colors corresponding to the value of the unevenness ΔF. For instance, when the unevenness ΔF is positive (+) with respect to the construction finished surface 53a, warm colors are used, and the color density or tone may be intensified for every 3 mm increase, for instance, in the unevenness ΔF. Conversely, when the unevenness ΔF is negative (−) with respect to the construction finished surface 53a, cool colors are used, and the color density or tone may be reduced for each 3 mm decrease, for instance.

It is to be noted that the threshold value used for the classification is not limited to 3 mm and can be set to an appropriate value, such as 5 mm or 1 cm, depending on the application. Alternatively, the classification may be represented in a single color with varying shades.

The arithmetic control module 35 converts unevenness data including unevenness ΔF data (i.e., high-low value data), unevenness ΔF distribution acquired from position information contained in the unevenness ΔF data and the distance measurement data, and the created unevenness map into data (i.e., converted unevenness data) with reference to the AR marker 32, and transmits the data to the portable terminal 18 via the communication module 36 in real time. It is to be noted that, in this specification, the unevenness data may be referred to as “measured data”, and the converted unevenness data may be referred to as “converted measured data”.

The terminal storage module 45 stores the converted unevenness data received from the portable terminal 18 via the terminal communication module 48. Based on an image including the AR marker 32 captured by the imaging module 46, the portable terminal 18 calculates relative position and relative positional relationship of the imaging module 46 with respect to the AR marker 32. Based on the relative position and the positional relationship, the stored converted unevenness data, and the image captured by the imaging module 46, the portable terminal 18 creates the AR image 51 with reference to the position of the portable terminal 18.

The AR image 51 is displayed on the terminal display unit 47 of the portable terminal 18, allowing the measurement operator to visually check it in real time. A description will be given below of the checking of the AR image 51 using the portable terminal 18.

The imaging module 46 of the portable terminal 18 captures an image of the construction floor surface 53 so that the images includes the AR marker 32. It is to be noted that the captured image may be either continuous images (video or moving image) or still images captured at a predetermined time interval.

The terminal control module 44 recognizes the AR marker 32 from the captured image, and calculates the relative position and the posture of the AR marker 32 with respect to the imaging module 46, based on the pattern 38 included in the image. Further, terminal control module 44 creates the AR image 51 based on the converted unevenness data received from the pole device 17 and the relative position and the posture of the AR marker 32. It is to be noted that the AR image 51 is created each time the imaging module 46 captures an image of the construction floor surface 53 including the AR marker 32.

The terminal control module 44 displays the created AR image 51 on the terminal display unit 47. The AR image 51, which includes information of a positional relationship between the AR marker 32 and the converted unevenness data, is displayed as viewed from the orientation (viewing orientation) in which the portable terminal 18 (the imaging module 46) has captured the image of the construction floor surface 53. Thus, the measurement operator can identify the displayed position of the converted unevenness data via the AR image 51 displayed on the terminal display unit 47.

Further, the AR image 51 may be, for example, an image of the construction floor surface 53 captured with the imaging module 46, onto which the converted unevenness data is overlaid. The converted unevenness data includes the unevenness ΔF data, the unevenness ΔF distribution, and the unevenness map 54 with reference to the AR marker 32, any of which may be appropriately selected and displayed as the AR image 51. It is to be noted that FIG. 8 shows the AR image 51 in which the unevenness data is represented as the unevenness map 54, and the unevenness map 54 is overlaid on the construction surface 53b.

The AR image 51 displayed on the terminal display unit 47, which represents the construction surface 53b and the unevenness map 54, is accurately displayed with the mutual position, the orientation, the tilt and the like thereof precisely aligned. Thus, the measurement operator can visually check the unevenness state of the construction surface 53b in real time, based on the AR image 51 displayed on the terminal display unit 47. The AR image 51 may be displayed continuously or intermittently.

The measurement operator can check the unevenness state in real time and, accordingly, can correct the unevenness in real time while the concrete is being placed. Thus, the measurement operator can carry out the concrete placing work while correcting the unevenness state.

It is to be noted that if the terminal input unit 49 of the portable terminal 18 is configured to allow input of a tilt, a tilt orientation, a rotation angle (viewing orientation), a size of the pattern 38 as they appear in an image with respect to an imaging optical axis of the imaging module 46, such a configuration enables the measurement operator to input a desired value for those parameters and view the unevenness data from any desired orientation.

Alternatively, the portable terminal 18 may employ a touch panel that integrates the terminal display unit 47 and a terminal input unit 49, thereby allowing the measurement operator to scroll the unevenness data on the terminal display unit 47 and to view the unevenness data from any orientation.

Further, when the unevenness map 54 is overlaid onto the construction surface 53b, which has already been concrete-placed, the measurement operator can check the finish state and finish accuracy of the construction surface 53b.

In the above explanation, it is assumed that the pole device 17 is vertically supported; however in practice, it should be taken into account that the pole device 17 may be inclined or subject to shaking. The pole device 17 includes the second tilt sensor 34. The second tilt sensor 34 detects the tilt of the pole device 17 (i.e., the tilt angle and the tilt orientation the pole 19 or the optical axis of the distance measurement camera 41) in real time, and the tilt detection result is input into the arithmetic control module 35 in real time. Further, the arithmetic control module 35 transmits the detection result (the tilt information) from the second tilt sensor 34 to the portable terminal 18 in real time.

The arithmetic control module 35 corrects, in real time, the measurement results (i.e., the measured distance and the measured position) of the distance measurement camera 41 based on the distance from the construction finished surface 53a to the measurement reference position, and the tilt detection result; and converts the measurement results into measurement results with reference to the AR marker 32. Thus, the arithmetic control module 35 can transmit the corrected accurate measured data to the portable terminal 18.

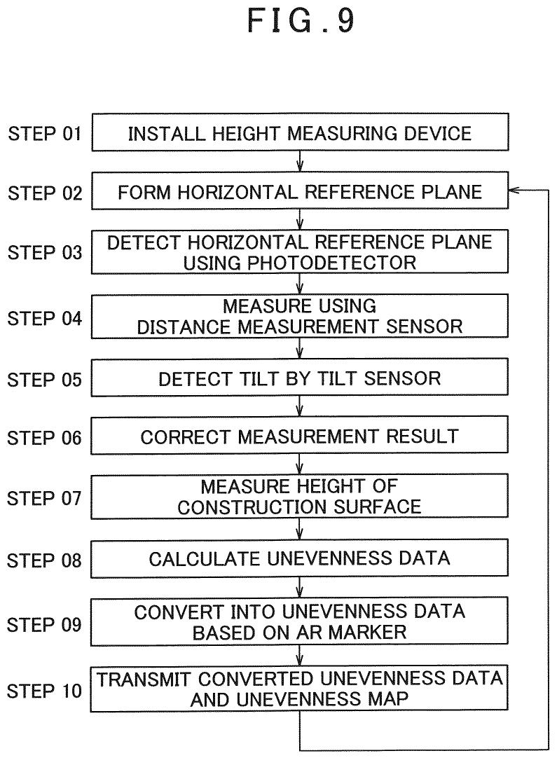

Next, with reference to a flow chart in FIG. 9, a description will be given of the unevenness measuring operation performed using the pole device 17. It is to be noted that a description will be given of the instance where the unevenness data acquired through the unevenness measuring operation is a visually recognizable unevenness map 54.

(Step 01) The height measuring device 16 (i.e., the laser level planer 21 in the present embodiment) is installed at a predetermined position. After the leveling operation for the device 16, the height of the laser beam projected by the height measuring device 16 is measured from a reference position (i.e., a position of the floor surface 52 in the present embodiment), thereby providing a known height value.

(Step 02) The height measuring device 16 emits a laser beam while rotating, thereby forming the horizontal reference plane O.

(Step 03) The pole device 17 detects the horizontal reference plane O using the photodetector 31. The height of the measurement reference position of the distance measurement sensor 33 (i.e., the distance measurement camera 41 in the present embodiment) is acquired with respect to the horizontal reference plane O from the photodetecting position of the photodetection sensor 37.

(Step 04) The pole device 17 measures the construction surface using the distance measurement sensor 33. It is to be noted that, since the marker reference position of the AR marker 32 is located at a known distance (i.e., an actually measured value) with respect to the measurement reference position, the construction surface 53b may be measured at any timing—beforehand, afterward or simultaneously—and the distance measurement camera 41 may be calibrated by comparing the measurement results with the actually measured value.

(Step 05) The pole device 17 detects the tilt of the optical axis of the distance measurement sensor 33 using the second tilt sensor 34.

(Step 06) The pole device 17 corrects the measurement results of the distance measurement sensor 33 based on the tilt detection result.

(Step 07) The pole device 17 obtains the height of the construction surface 53b with respect to the horizontal reference plane O, based on the corrected measurement result and the height of the measurement reference position with respect to the horizontal reference plane O. It is to be noted that the distance measurement sensor 33 is implemented as a distance measurement camera 41, which obtains an image of the construction surface 53b and the height of each pixel in the image.

(Step 08) The pole device 17 calculates the height difference (i.e., measurement error) between a preset construction finished surface 53a, and the measured construction surface 53b, and acquires the high-low information (i.e., unevenness data) in real time. The high-low information can be acquired for each pixel, so that the vertical difference information over the entire measurement area measurable with the distance measurement camera 41, which constitutes the unevenness map 54.

(Step 09) The acquired unevenness map 54 is an unevenness map 54 with reference to the construction finished surface 53a, and the pole device 17 converts the unevenness data into unevenness data with reference to the AR marker 32 based on a known positional relationship between a measurement reference position and an AR marker reference position, and converts the unevenness map 54 into an unevenness map 54 with reference to the AR marker 32 based on the converted unevenness data.

(Step 10) The converted unevenness data and unevenness map 54 are transmitted to the portable terminal 18 in real time.

To change the measuring position and continue the measurement, Steps 02 to 10 are repeatedly performed. It is to be noted that the aforementioned unevenness data and the unevenness map 54 together may be referred to as measured data. Further, the converted unevenness data and the unevenness map 54 together may be referred to as converted measured data.

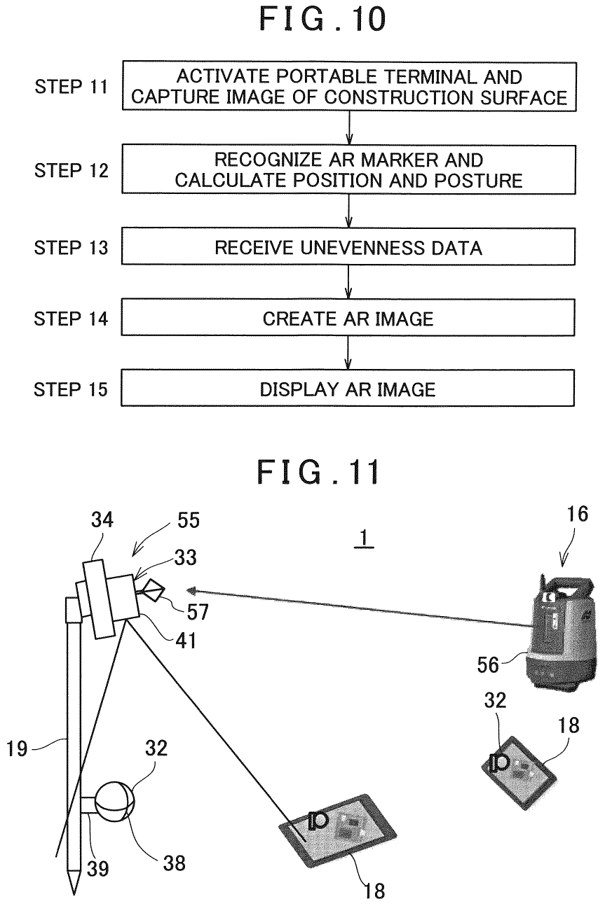

Next, with reference to the flow chart of FIG. 10, a description will be given of the unevenness measuring operation in the portable terminal 18.

(Step 11) At first, the portable terminal 18 is activated, and the imaging module 46 of the portable terminal 18 captures an image of the construction surface 53b so that the image includes the AR marker 32.

(Step 12) The portable terminal 18 recognizes the AR marker 32 in the image, detects the tilt, the tilt orientation, and the rotation angle (i.e., a viewing orientation) of the AR marker 32, based on the shape of the pattern 38 formed on the AR marker 32, detects (calculates) the size of the pattern 38, and calculates the relative position and the posture of the AR marker 32 with respect to the portable terminal 18 in real time.

(Step 13) The portable terminal 18 receives the converted unevenness map and unevenness data from the pole device 17.

(Step 14) The portable terminal 18 creates the AR image 51 based on a relative positional relationship between the portable terminal 18 and the AR marker 32, and the unevenness data received from the pole device 17.

(Step 15) The portable terminal 18 displays the created AR image 51 on the terminal display unit 47. It is to be noted that, as the AR image 51 displayed on the terminal display unit 47, the unevenness map 54 may be overlaid on the construction surface 53b, or the unevenness data may be overlaid on the unevenness map 54. The mode of displaying the unevenness distribution information can be selected via the terminal input unit 49 of the portable terminal 18.

Steps 11 to 15 are performed in real time and in parallel with the unevenness measurement performed with the pole device 17. Further, the detection of the AR marker 32 and the creation of the AR image 51 are performed for each portable terminal 18, so that the unevenness measurement can be recognized from a plurality of the portable terminals 18 with respect to a single pole device 17.

In the second embodiment, acquiring an image including the AR marker 32, which is a three-dimensional measurement target integrated with the pole device 17 allows the system to obtain, based on the AR marker 32 in the image, the relative position and posture of the pole device 17 with respect to the portable terminal 18 and the viewing orientation.

Thus, it is unnecessary to provide a projector on the pole device 17 for projecting the AR marker onto the construction floor surface 53, which may reduce the number of components and overall cost.

Further, this configuration allows the AR marker 32 integrated with the pole device 17 to be recognized and the AR image 51 to be displayed, enabling the unevenness data to be visually confirmed even at a bright construction site, where viewing projected videos or images is not suitable. This improves workability.

It is to be noted that, although a description is given of unevenness measurement in this embodiment, the embodiment is not limited to unevenness measurement, and may be applied to the measurement of other surface conditions, including those involving curved or inclined surface.

Although the description employs a smartphone and tablet as an example, the portable terminal 18 in this embodiment may be implemented using a head-mounted display (HMD). The HMD may function as both a displaying device and the portable terminal 18 by incorporating a terminal control module 44, a terminal storage module 45, and the like in the same manner as shown in FIG. 5.

When a portable terminal 18 is implemented using an HMD, the measurement operator can free both hands, allowing the operator to recognize changes in the construction state and the unevenness state in real time while carrying out the work.

Further, in the second embodiment, the AR image 51 is created and displayed based on the AR marker 32 in the image captured by the imaging module 46. Alternatively, even when the AR marker 32 is out of the field of view of the imaging module 46, the AR image 51 may be created and displayed based on the last recognized position of the AR marker 32 and data from the second tilt sensor 34, such as a gyroscope sensor and an acceleration sensor (IMU).

Further, to cause the AR maker 32 itself to emit light, the AR marker 32 may be formed using fluorescent paint or may be displayed on a monitor, for example, thereby allowing the AR marker 32 to be recognizable even at a dark construction site.

In this embodiment, the measurement operator holds the pole device 17, allowing the operator to move it freely. Thus, by moving the pole device 17 to different locations, the unevenness measurement can be performed over a wider area.

With reference to FIGS. 11 to 14, a third embodiment will be described. It is to be noted that, in FIG. 11, those that are equivalent to components as shown in FIG. 1 are referred by the same numeral, and the detailed description thereof will be omitted.

FIG. 11 shows general features of a surveying system according to the third embodiment. Similar to the second embodiment, the surveying system 1 according to the third embodiment mainly includes a height measuring device 16, a pole device 55, and a portable terminal 18. It is to be noted that the portable terminal 18 is the same as that in the second embodiment, and hence a detailed description thereof will be omitted.

In the third embodiment, an electro-optical distance device with a tracking function, such as a total station 56, is employed as the height measuring device 16. It is to be noted that other types of the measuring devices with a tracking function may include, for example, a device with a tracking function based on images using an image sensor, or a device with the shape tracking function using a laser scanner.

The total station 56 is set up at a position with horizontal leveling. The total station 56 is installed at a known height. That is, the total station 56 has a survey reference point and is installed in such a manner that three-dimensional coordinates of the survey reference point, or at least height coordinates (height positions) are set and known. For instance, with reference to FIG. 14, assuming that the total station 56 is installed on the floor surface 52 and that the height of the floor surface 52 serves as a survey reference height, a height D from the floor surface 52 to the survey reference point is known.

The pole device 55 functions as a measuring device, and has a prism 57 with retroreflective characteristics as an measurement target for a height measurement. The position of the optical center of the prism 57 and a measurement reference position of the distance measurement camera 41 have a known positional relationship. It is to be noted that a reflective sheet may be employed as an measurement target.

The total station 56 includes a telescope module (not shown in the FIG. 14) configured to sight the prism 57 as a measurement target, emits a tracking light through the telescope module, and tracks the prism 57. Further, the total station 56 emits a distance measuring light through the telescope module, receives a reflected light from the prism 57, and performs electro-optical distance measurement with respect to the prism 57.

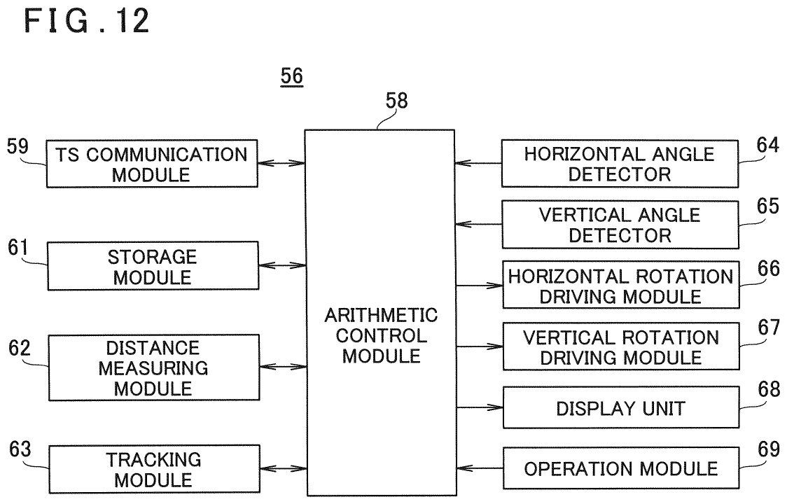

With reference to FIG. 12, a description will be given of a general configuration of the total station 56.

The total station 56 mainly includes an arithmetic control module 58, a total station (TS) communication module 59, a storage module 61, a distance measurement module 62, a tracking module 63, a horizontal angle detector 64, a vertical angle detector 65, a horizontal rotation driving module 66, a vertical rotation driving module 67, a display unit 68, and an operation module 69.

The arithmetic control module 58 controls these modules integrally and individually, including drive control and synchronization control, especially for the TS communication module 59, the distance measuring module 62, the tracking module 63, the horizontal rotation driving module 66, the vertical rotation driving module 67 and the display unit 68.

The TS communication module 59 performs data communication with the pole device 55. The tracking module 63 emits a tracking light to the prism 57 as an tracking target, receives a reflected light, and tracks the tracking target. In parallel with the tracking of the tracking module 63, the distance measurement module 62 emits the distance measuring light to the prism 57 as an measurement target, receives the reflected light, and measures the distance to the prism 57.

The horizontal angle detector 64 has a reference point, and is configured to detect the horizontal angle of the optical axis of a telescope with respect to this reference point. The vertical angle detector 65 is configured to detect a high-low angle with respect to the horizontal plane.

The horizontal rotation driving module 66 and the vertical rotation driving module 67 rotate the telescope in a vertical and horizontal direction, respectively, to track the prism 57. Further, the horizontal angle detector 64 and the vertical angle detector 65 detect a horizontal angle and a vertical angle during distance measurement. Accordingly, the total station 56 measures the distant to the prism 57 as well as the three-dimensional coordinates of the prism 57.

The TS communication module 59 transmits the measured three-dimensional coordinates to the pole device 55 in real time.

The operation module 69 receives input operations for the total station 56 from the measurement operator, including turning ON/OFF, configuration setting, and condition setting of each operation. The display unit 68 displays the operating state of the total station 56 as affected by these operations.

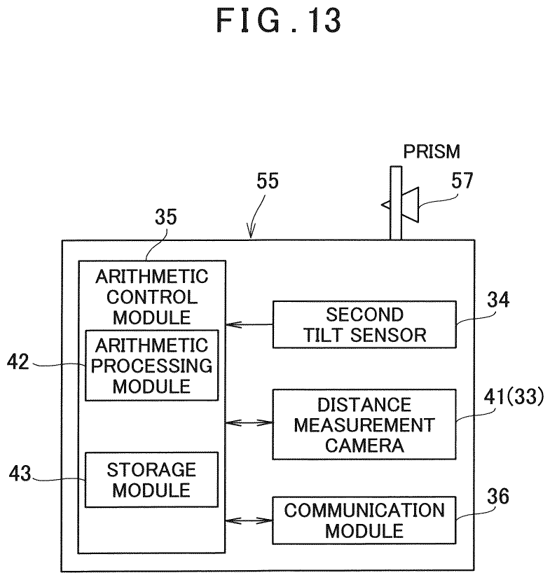

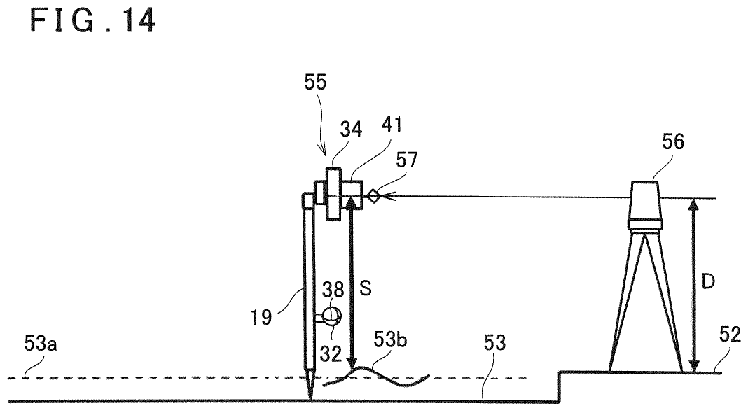

FIG. 13 shows general features of the pole device 55 according to the third embodiment. The pole device 55 according to the third embodiment and the pole device 17 according to the second embodiment have substantially the same structure; however, the pole device 55 includes the prism 57 in place of the photodetector 31 (see FIG. 4), and further includes a communication module 36 for data communication with the total station 56.

With reference to FIG. 14, A description will be given of the unevenness measurement in the third embodiment. It is to be noted that the components in FIG. 14 and the corresponding components shown in FIG. 6 are denoted by the same numeral, and the detailed description thereof will be omitted.

The total station 56 measures the prism 57, and transmits three-dimensional coordinates of the prism 57, as measurement data, to the communication module 36 of the pole device 55 using the TS communication module 59. The communication module 36 receives the three-dimensional data and inputs it to the arithmetic control module 35.

The three-dimensional data is further input to the arithmetic processing module 42, and the arithmetic processing module 42 acquires (calculates) the height of the prism 57 based on the three-dimensional data, that is, the height of the position at which the distance measuring light is emitted by the total station 56.

The acquired height of the position at which the distance measuring light is emitted corresponds to the height of the prism 57 (i.e., the height of the optical center of the prism 57) with reference to the floor surface 52 (see FIG. 6).

Further, the arithmetic processing module 42 acquires the height of the distance measurement camera 41 with reference to the floor surface 52, based on a known positional relationship between the optical center of the prism 57 and the measurement reference position of the distance measurement camera 41, and on the height of the prism 57.

Accordingly, the pole device 55 can measure an unevenness state of the construction surface 53b based on the measurement result from the distance measurement camera 41.

In the third embodiment, the height of the prism 57 measured by the total station 56 serves as a reference of the unevenness measurement, and the total station 56 and the prism 57 function as a reference level measuring device that measures a level that serves as a reference of unevenness measurement.

The processes of creating an unevenness map 54, and displaying an AR image 51 on the terminal display unit 47 of the portable terminal 18 are the same as those in the second embodiment, and hence a detailed description thereof will be omitted.

Using the total station 56 as a height measuring device 16, which tracks and measures the pole device 55 allows the pole device 55 to be configured as a handheld-type device, which does not need to be fixed to the construction floor surface 53.

The total station 56 measures the height of the pole device 55 (i.e., the height of a prism 57) in real time, and a second tilt sensor 34 measures the tilt of the pole device 55 (i.e., the tilt of the distance measurement sensor 33) in real time. Further, by using the measured tilt for correcting the measured height of the pole device 55, an accurate height of the distance measurement sensor 33 can be obtained. Thus, an accurate amount of unevenness is determined based on the measured value from the distance measurement sensor 33.

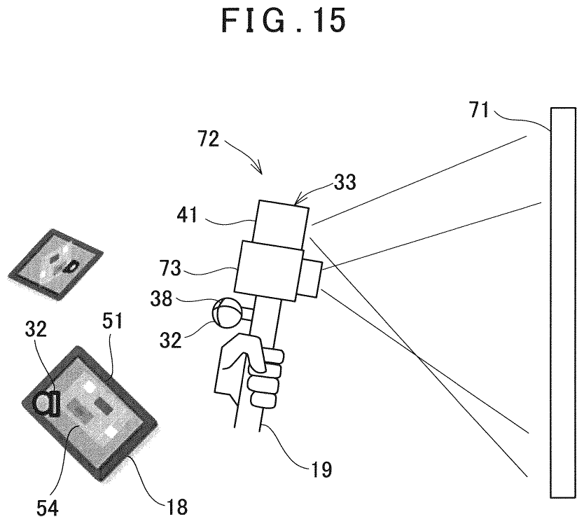

It is to be noted that the handheld type may be configured to integrally support the distance measurement sensor 33 and the arithmetic control module 35, instead of the pole 19 of the pole device 55; Various kinds of handheld forms are possible, such as a form with a pole as a short rod-shaped handle (see FIG. 15), a form with a distance measurement sensor 33 and an arithmetic control module 35 integrated together and with a handle attached thereto, a helmet-mounted form, a backpack type, and even a drone-mounted type instead of the pole 19.

Further, the unevenness map, which is corrected in real time, is transmitted to the portable terminal 18.

It is to be noted that, when the pole device 55 is configured to be trackable from the total station 56, the pole device 55 can be mounted on a remotely operable mobile carriage.

With reference to FIG. 15, a fourth embodiment will be described.

The fourth embodiment relates to an instance in which the measurement target surface is a vertical surface, such as a wall surface, and for measuring unevenness of the vertical surface (irregularities).

FIG. 15 shows a schematic diagram of the fourth embodiment. In FIG. 15, reference numeral 71 denotes an measurement target surface, which is a wall surface vertical with respect to the ground. Further, the components in FIG. 15 and corresponding components shown in FIG. 2 are denoted by the same numeral, and the detailed description thereof will be omitted. It is to be noted that the wall surface may be inclined with respect to the vertical plane.

The surveying system 1 according to the fourth embodiment mainly includes a pole device 72 and a portable terminal 18. Further, the pole device 72 functions as a measuring device, and is configured to be portable. It is to be noted that the pole device 72 may also be fixed to a floor surface, as those in the second embodiment. Further, the portable terminal 18 is the same as those in the second embodiment, and hence a detailed description thereof will be omitted.

The pole device 72 according to the fourth embodiment includes a distance measurement sensor 33 (a distance measurement camera 41) as a first measuring instrument for recognizing the measurement target surface 71 spatially (in a manner of the three dimensions); an infrared camera 73 as a second measuring instrument capable of acquiring information, such as unevenness data for creating an AR image 51; and an AR marker 32.

The infrared camera 73 and the distance measurement camera 41 are attached such that their optical axes are orthogonal to the axis center of the pole 19. Further, the optical axis of the infrared camera 73 is parallel to the optical axis of the distance measurement camera 41, and the distance between the optical axes is known.

The AR marker 32 is provided at a predetermined position on the pole 19, and the positional relationships among a geometric center (reference position) of the AR marker 32, an optical center of the infrared camera 73, and an optical center of the distance measurement camera 41 is known.

The infrared camera 73 acquires an infrared image including temperature information of each pixel of the imaging element. That is, the infrared camera 73 can acquire a temperature distribution of the measurement target surface 71. Further, analyzing the temperature distribution in the infrared image allows detection of defects, such as delamination and cracking, occurring on the measurement target surface.

Further, the distance measurement camera 41 is a time-of-flight (TOF) camera and acquires a distance information image including distance information for each pixel of the imaging element. That is, the distance measurement camera 41 can acquire surface properties of the measurement target surface 71.

The pole device 72 can create an image including both distance information and temperature information for each pixel, based on the known positional relationship between the optical center of the infrared camera 73 and the optical center of the distance measurement camera 41. The created image is transmitted to the portable terminal 18.

The portable terminal 18 recognizes the AR marker 32 and the pattern 38 formed on the AR marker 32 by capturing an image that includes the AR marker 32, and determines the relative position and posture of the pole device 72 with respect to the portable terminal 18, based on the shape, size, rotation angle (viewing orientation), and the like of the pattern 38.

Further, the portable terminal 18 creates an AR image 51 based on the received image and the position or posture of the pole device 72. In the fourth embodiment, the AR image 51 may be an image in which a temperature distribution is overlaid on the measurement target surface 71, and may be displayed on the terminal display unit 47 as viewed from the orientation (viewing orientation) in which the portable terminal 18 captured the image of the target surface.

The measurement operator can identify the positions of defects, such as delamination and cracking, occurring on the measurement target surface 71, based on the AR image 51 displayed on the terminal display unit 47, and can carry out work, such as restoration.

The fourth embodiment employs the distance measurement camera 41 as a first measuring instrument (the distance measurement sensor 33), which acquires distance information of the imaging area for spatially recognizing the measurement target surface 71, and an infrared camera 73 as a second measuring instrument, which acquires information for creating an AR image 51; However, the embodiment is not limited to these, and various types of measuring instruments may be employed as appropriate.

For example, to spatially recognize the measurement target surface 71, it is sufficient to measure at least three points on the surface 71. For this purpose, various types of measuring instruments may be employed, such as an instrument using light detection and ranging (LiDAR), an instrument using structured light, or an instrument using a stereo camera.

Further, as a second measuring instrument for creating an AR image, for example, a spectrometer may be employed, for example, to detect the salt concentration of the measurement target surface 71.

Further, as a second measuring instrument, a reference level measuring device may be employed, such as the device described in the second embodiment and the third embodiment, which combines a height measuring device and a distance measurement sensor (see also the fourth embodiment, in which a reference level measuring device measures a distance to the measurement target surface 71). In this instance, the distance measurement sensor serves as both a first and a second measuring instrument and performs unevenness measurement on the measurement target surface 71, which is a wall surface, by using a height measurement system.

It is to be noted that, although a description is given of the instance where the measurement target surface 71 is a wall surface in the fourth embodiment, the embodiment is not limited to wall surfaces, and may be similarly applied to ceiling surfaces.

Further, in the first embodiment to the fourth embodiment, the AR marker 32 is provided on the support 8 (see FIG. 1) or on the pole 19. Alternatively, the AR marker 32 may be provided on the other members that supports a measuring instrument or a measuring device, such as the pole devices 17, 72.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

### REFERENCE SIGNS LIST

1 Surveying system
2 Measuring device
3 Portable terminal
7 AR marker
11 Camera
16 Height measuring device
17 Pole device
18 Portable terminal
22 Control module
31 Photodetector
32 AR marker
33 Distance measurement sensor
41 Distance measurement camera
46 Imaging module
47 Terminal display unit
51 AR image
54 Unevenness map

1. A surveying system comprising a measuring device and a portable terminal, each comprising:
one or more hardware-processors;
one or more memories; and
one or more programs stored in the one or more memories, the one or more programs being executable by the one or more hardware-processors, to cause the one or more hardware-processors to collectively perform operations, wherein:
the measuring device comprises:
a measuring instrument configured to measure a measurement target;
an AR marker disposed in a known positional relationship with a measurement reference position of the measuring instrument;
a control module configured to convert measured data acquired by the measuring instrument into measured data with reference to the AR marker; and
a communication module configured to transmit the converted measured data;
and the portable terminal comprises:
a camera configured to capture an image of the measurement target and the AR marker;
a terminal communication module configured to receive the converted measured data;
a terminal control module; and
a display unit;
wherein the terminal control module is configured to:
recognize the AR marker from the captured image;
create an AR image based on the recognized
AR marker and the converted measured data; and
display the AR image on the display unit.

2. The surveying system according to claim 1,
wherein the AR marker comprises a predetermined pattern; and
wherein the terminal control module is further configured to:
calculate a viewing orientation of the measurement target as viewed from the portable terminal based on the predetermined pattern;
calculate a relative position and a posture of the measuring device with respect to the portable terminal based on recognition of a shape of the pattern; and
correct a displayed position of the AR image on the display unit based on the calculated viewing orientation, relative position, and posture.

3. The surveying system according to claim 1,
wherein the measuring device further comprises a tilt sensor; and
wherein the control module is further configured to correct the converted measured data based on a detection result of the tilt sensor.

4. The surveying system according to claim 1,
wherein the surveying system further comprises a reference level measuring device configured to set a reference level with respect to the measurement target; and
wherein the converted measured data is unevenness data with respect to the reference level.

5. The surveying system according to claim 4,
wherein the control module is configured to create an unevenness map with colors corresponding to the unevenness data.

6. The surveying system according to claim 4,
wherein the reference level measuring device comprises a photodetector provided on the measuring device and a laser level planer that is configured to form a reference plane at a predetermined distance with respect to the measurement target.

7. The surveying system according to claim 4,
wherein the reference level measuring device comprises a prism provided on the measuring device and a total station provided at a known height.

8. The surveying system according to claim 1,
wherein said surveying system further comprises a second measuring instrument configured to acquire information of the measurement target; and
wherein the terminal control module is configured to create the AR image based on the converted measured data and information acquired by the second measuring instrument.

9. A surveying method used in a surveying system comprising a measuring device including an AR marker and a portable terminal including a display unit, the surveying method comprising steps performed by one or more hardware processors executing one or more programs stored in one or more memories, the one or more programs being executable by the one or more hardware processors to cause the one or more hardware processors to perform operations comprising:
measuring a measurement target using the measuring device to acquire measured data;
converting the measured data into data with reference to the AR marker;
transmitting converted measured data to the portable terminal;
acquiring an image of the measurement target, the image includes the AR marker;
recognizing the AR marker from the image;
creating an AR image based on a result of the recognition of the AR marker and the converted measured data; and
displaying the AR image on the display unit.
